(19) United States
(12) Patent Application Publication
(10) Pub. No.: US 2024/0145105 A1
(43) Pub. Date: May 2, 2024

(54) NUCLEAR REACTOR FUEL

(71) Applicant: Oklo Inc., Santa Clara, CA (US)

(72) Inventor: Jacob DeWitte, Mountain View, CA (US)

(21) Appl. No.: 18/547,829

(22) PCT Filed: Feb. 25, 2022
(86) PCT No.: PCT/US2022/018036

§ 371 Date: Aug. 24, 2023

Related U.S. Application Data
(60) Provisional application No. 63/153,439, filed on Feb. 25, 2021.

(51) Int. Cl. G21C 3/62; G21C 21/02

(52) U.S. Cl. CPC G21C 3/626; G21C 21/02

(57) ABSTRACT

A nuclear fuel system (210), nuclear fuel particle (100), and method for operating a nuclear fuel system are disclosed. A nuclear fuel system includes a matrix (130) material and a plurality of fuel particles (100) disposed in the matrix material, each fuel particle comprising a fuel kernel (110) and a fuel coating (120) that covers a surface of the fuel kernel. The fuel kernel comprises a fissile material including one or more of uranium-233, uranium-235, or plutonium-239. The fuel coating is functionally graded in density. A density of the fuel coating increases along an outward radial direction referenced to the center of the fuel kernel. The fuel coating comprises a neutron moderating material. A volume fraction of fuel particles is thirty-five percent or more of a volume of a nuclear fuel compact.

### TECHNICAL FIELD

The present disclosure relates generally to nuclear reactors, and more specifically to particle fuel forms.

### BACKGROUND

Global energy growth and a drive to reduce pollution and emissions is stimulating new activity around the commercialization and design of new reactor technologies. Some of these technologies include reactors designed to operate at high temperatures and use coated particle fuels to support high temperature performance. Coated particle fuel designs often use three layers of coatings, often referred to as tri-isotropic (TRISO) fuel. These coatings often include an inner graphite layer, a silicon carbide layer, and an outer graphite layer. These layers are included to retain fission products. The different materials used on each particle introduce fabrication complexities and costs.

### SUMMARY

Techniques for fabrication and use of functionally graded coated particle fuel are disclosed. The disclosed techniques can simplify fabrication of nuclear particle fuel, reduce costs, and increase fissile density. An example fuel particle includes a single porous coating around a fuel kernel. Many particles can be placed in a matrix that provides fission product retention.

In an example implementation, a nuclear fuel system includes a matrix material; and a plurality of fuel particles disposed in the matrix material. Each fuel particle includes a fuel kernel; and at least one fuel coating that covers a surface of the fuel kernel.

In an aspect combinable with the example implementation, the fuel kernel includes a fissile material.

In another aspect combinable with any of the previous aspects, the fissile material includes one or more of uranium-233, uranium-235, or plutonium-239, uranium oxide, uranium oxycarbide, uranium nitride, uranium silicide, or uranium boride.

In another aspect combinable with any of the previous aspects, the at least one fuel coating is functionally graded in density.

In another aspect combinable with any of the previous aspects, a density of the at least one fuel coating increases along an outward radial direction referenced to a center of the fuel kernel.

In another aspect combinable with any of the previous aspects, the surface includes an entire surface of the fuel kernel.

In another aspect combinable with any of the previous aspects, the at least one fuel coating is fabricated using chemical vapor deposition methods or spark plasma sintering methods.

In another aspect combinable with any of the previous aspects, the at least one fuel coating includes a neutron moderating material.

In another aspect combinable with any of the previous aspects, the neutron moderating material includes one or more of graphite or beryllium.

In another aspect combinable with any of the previous aspects, the at least one fuel coating includes a cercer material.

In another aspect combinable with any of the previous aspects, the cercer material includes one or more of a boride, a nitride, or a silicide.

In another aspect combinable with any of the previous aspects, the at least one fuel coating includes an interior layer and an exterior layer.

In another aspect combinable with any of the previous aspects, the exterior layer includes a same material composition as the matrix material.

In another aspect combinable with any of the previous aspects, the interior layer includes a material having a reduced density compared to a density of a material of the exterior layer.

In another aspect combinable with any of the previous aspects, the material of the interior layer includes at least one of graphite, silicon carbide, niobium carbide, hafnium carbide, tantalum carbide, titanium carbide or zirconium carbide.

In another aspect combinable with any of the previous aspects, the material of the interior layer includes at least one of hafnium nitride, boron nitride, titanium nitride or zirconium nitride.

In another aspect combinable with any of the previous aspects, the material of the interior layer includes at least one of hafnium boride, niobium boride, titanium boride or zirconium boride.

In another aspect combinable with any of the previous aspects, the matrix material is fabricated using spark plasma sintering methods.

In another aspect combinable with any of the previous aspects, the matrix material includes one or more of silicon carbide, niobium carbide, hafnium carbide, tantalum carbide, titanium carbide or zirconium carbide.

In another aspect combinable with any of the previous aspects, the matrix material includes a neutron moderating material.

In another aspect combinable with any of the previous aspects, the at least one fuel coating and the matrix material are materially compatible.

Another aspect combinable with any of the previous aspects further includes a nuclear fuel compact manufactured via spark plasma sintering, wherein the plurality of fuel particles and the matrix material are disposed in the nuclear fuel compact.

In another aspect combinable with any of the previous aspects, a volume fraction of fuel particles is thirty-five percent or more of a volume of the nuclear fuel compact.

In another aspect combinable with any of the previous aspects, a volume fraction of fuel particles is fifty-percent or more of a volume of the nuclear fuel compact.

In another aspect combinable with any of the previous aspects, the fuel kernel includes at least one of an oxide, a carbide, an oxycarbide, a boride, or a nitride.

In another aspect combinable with any of the previous aspects, the at least one fuel coating that covers the surface of the fuel kernel includes a single coating layer including a porous material.

In another example implementation, a nuclear fuel particle includes a fuel kernel; and at least one fuel coating that covers a surface of the fuel kernel.

In an aspect combinable with the example implementation, the fuel kernel includes a fissile material.

In another aspect combinable with any of the previous aspects, the fissile material includes one or more of uranium-233, uranium-235, or plutonium-239.

In another aspect combinable with any of the previous aspects, the at least one fuel coating is functionally graded in density.

In another aspect combinable with any of the previous aspects, a density of the at least one fuel coating increases along an outward radial direction referenced to the center of the fuel kernel.

In another aspect combinable with any of the previous aspects, the surface includes an entire surface of the fuel kernel.

In another aspect combinable with any of the previous aspects, the at least one fuel coating is fabricated using chemical vapor deposition methods or spark plasma sintering methods.

In another aspect combinable with any of the previous aspects, the at least one fuel coating includes a neutron moderating material.

In another aspect combinable with any of the previous aspects, the neutron moderating material includes one or more of graphite or beryllium.

In another aspect combinable with any of the previous aspects, the at least one fuel coating includes a cercer material.

In another aspect combinable with any of the previous aspects, the cercer material includes one or more of a boride, a nitride, or a silicide.

In another aspect combinable with any of the previous aspects, the at least one fuel coating includes an interior layer and an exterior layer.

In another aspect combinable with any of the previous aspects, the exterior layer includes a same material composition as a matrix material that surrounds the nuclear fuel particle.

In another aspect combinable with any of the previous aspects, the interior layer includes a reduced density material having a reduced density compared to the exterior layer.

In another aspect combinable with any of the previous aspects, the reduced density material includes at least one of graphite, silicon carbide, or zirconium carbide.

In another aspect combinable with any of the previous aspects, the at least one fuel coating is materially compatible with matrix material that surrounds the nuclear fuel particle.

In another aspect combinable with any of the previous aspects, the fuel kernel includes at least one of an oxide, a carbide, an oxycarbide, a boride, or a nitride.

In another aspect combinable with any of the previous aspects, the at least one fuel coating that covers the surface of the fuel kernel include a single coating layer including a porous material.

In another example implementation, a method includes facilitating a fission process with a plurality of nuclear fuel elements; generating heat from the fission process; and producing electrical power using the heat generated from the fission process. Each nuclear fuel element of the plurality of nuclear fuel elements includes a matrix material; and a plurality of fuel particles disposed in the matrix material, each fuel particle including a fuel kernel, and at least one fuel coating that covers a surface of the fuel kernel.

In another example implementation, a method of fabricating a nuclear fuel element includes forming a plurality of fuel particles using a sol-gel process; drying the fuel particles; calcining the fuel particles; sintering the fuel particles; coating the fuel particles with a fuel coating; packing the coated fuel particles in a matrix material; and sintering the coated fuel particles in the matrix material to form the nuclear fuel element.

An aspect combinable with the example implementation further includes coating the nuclear fuel element in a fuel element coating.

Implementations of functionally graded coated particle fuel according to the present disclosure can result in one or more of the following advantages. For example, the use of a single coating layer, or two coating layers, can simplify fabrication and reduce costs of particle fuel compared to a particle fuel that includes three layers. In some examples, a reduced number of coating layers can increase fissile density and improve efficiency of power generation. In some examples, a single coating can be used around the fuel kernel, and the fuel particles can be disposed in a matrix that provides fission product retention. In this way, adequate fission product retention can be achieved with a reduced number of coating layers. The coated fuel particles with reduced density coatings can be implemented to accommodate fission gases and fuel swelling. The disclosed systems and techniques allow for greater fuel particle packing fractions than other approaches, as the minimum spacing between particles can be reduced. Additionally, the disclosed systems and techniques can be implemented to accommodate larger fuel particle sizes.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a coated fuel particle according to the present disclosure.

FIGS. 2A and 2B are schematic illustrations showing top cross-sectional views of an example implementation of a coated particle fuel compact according to the present disclosure.

FIGS. 3A and 3B are schematic illustrations showing side cross-sectional views of an example implementation of a coated particle fuel compact according to the present disclosure.

FIG. 4 is a flow diagram of an example process for fabricating fuel elements according to the present disclosure.

Embodiments of the present disclosure will now be described in detail with reference to the drawings, which are provided as illustrative examples of the inventive embodiments so as to enable those skilled in the art to practice the example embodiments. Notably, the figures and examples are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the example embodiments.

### DETAILED DESCRIPTION

Global energy growth and a drive to reduce pollution and emissions is stimulating new activity around the commercialization and design of new reactor technologies. Some of these technologies include reactors designed to operate at high temperatures and use coated particle fuels to support high temperature performance. Coated particle fuel designs can use three layers of coatings, often referred to as tri-isotropic (TRISO) fuel. These coatings can include an inner graphite layer, a silicon carbide layer, and an outer graphite layer. These layers are included to retain fission products. The different materials used on each particle introduce fabrication complexities and costs. To simplify fabrication, reduce costs, and increase fissile density, a single coating can be used around the fuel, and the particles are placed in a matrix that provides fission product retention.

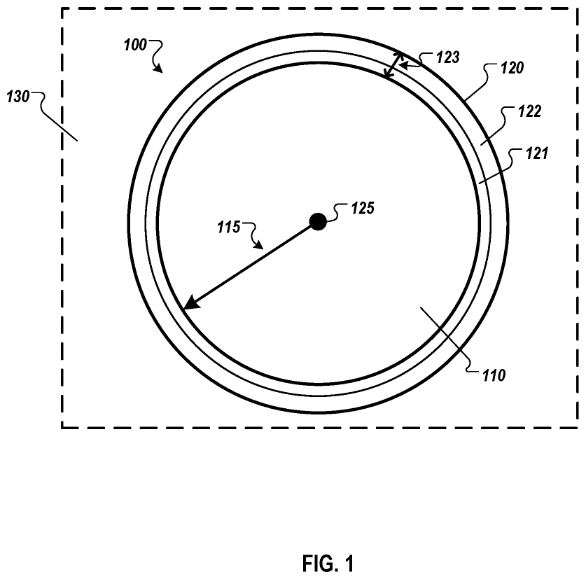

FIG. 1 is a schematic illustration of an example implementation of a coated fuel particle 100 according to the present disclosure. A nuclear reactor can include fuel including a fissile material such as uranium-233, uranium-235, or plutonium-239. The fissile material can be in the form a fuel kernel 110. The fuel kernel 110 can be, for example, a spherical kernel of fissile material. The fuel kernel 110 is coated in a fuel coating 120 including one or more layers 121, 122 of porous coating materials surrounding the fuel. Matrix material 130 surrounds the coated fuel particle 100.

The reactor can be cooled by coolants such as a gas, a supercritical fluid, or a liquid. Fissile material can be contained in fuel compacts, or fuel elements, and the fuel elements can be held inside a reactor vessel.

The fissile material can be an oxide, a carbide, an oxycarbide, a boride, or a nitride. If a boride is used, the boron can be isotopically enriched in the isotope boron 11. The fuel kernel 110 can have a radius 115 of, e.g., 0.03 centimeters (cm) or greater, 0.10 cm or greater, or 0.2 cm or greater.

Surrounding the fuel kernel 110 is a fuel coating 120 including the one or more coating layers 121, 122. The fuel coating 120 functions as a porous buffer layer between the fuel kernel 110 and the matrix material 130. The fuel coating 120 can have a thickness 123 of, e.g., 0.01 cm or less, 0.02 cm or less, or 0.03 cm or less.

In some implementations, the fuel coating 120 includes a single coating layer including a porous material. In some implementations, the single coating layer has a uniform material composition.

In some implementations, the fuel coating 120 includes an interior layer 121 and an exterior layer 122. In some implementations, the fuel coating 120 can include additional coating layers between the interior layer 121 and the exterior layer 122. In some implementations, each coating layer 121, 122 has a different material composition than each other coating layer.

In some implementations, the interior layer 121 is formed from a reduced density material, such as graphite, silicon carbide, or zirconium carbide to accommodate fuel swelling and fission gas release.

In some implementations, the exterior layer 122 has a same material composition as the matrix material. In some examples, the fuel coating 120 and the matrix material 130 are materially compatible. For example, the exterior layer 122 can include materials that are physically and chemically compatible with the matrix material 130 at high temperatures (e.g., between 1500° C. and 3000° C., and optionally over 3000° C.). Materials that are compatible can be, for example, materials that are resistant to oxidation and corrosion when in contact.

In some examples, the fuel coating 120 can include materials made from borides, nitrides, or silicides. In some examples, the materials of the fuel coating 120 can be combined as ceramic particles dispersed in a ceramic matrix, e.g., a cercer material.

The fuel coating 120 can be functionally graded in density. Density is described herein in terms of relative density. The relative density can be defined as the ratio of the volume of solid material to the total volume of the material. The relative density can be expressed in terms of the void volume fraction, e.g., the ratio of the volume of voids to the total volume of the material. It follows that in relation to porosity or void fraction of materials, void fraction and relative density sum to one hundred percent. For example, a material having a void fraction of seventy percent can be described as having a density of thirty percent.

A functionally graded coating material can have a varied composition and structure. For example, the functionally graded fuel coating 120 may be denser near the exterior surface, with density gradually decreasing along an inward radial direction. The inward radial direction can be defined as a direction from an outer surface of the fuel coating 120 towards the center 125 of the fuel kernel 110. In some implementations, the density decreases approximately linearly through the fuel coating 120 along the inward radial direction. In some implementations, the density decreases step-wise through the fuel coating 120 along the inward radial direction.

Thus, portions of the fuel coating 120 that are nearer to the fuel kernel 110 are generally less dense than portions of the fuel coating 120 that are further from the fuel kernel 110. The reduced density material of the fuel coating 120 adjacent to the fuel kernel 110 can accommodate fission gases and fuel swelling.

A functionally graded coating can have densities ranging, e.g., from approximately thirty percent to approximately seventy percent. In an example implementation, inner portions of the fuel coating 120 (e.g., portions nearest to the fuel kernel 110) have a density of thirty percent or more, and outer portions of the fuel coating 120 (e.g., portions farthest from the fuel kernel 110) have a density of seventy percent or less.

In some implementations, one or more of the coating layers around the fuel kernel 110 may have a particular density, such that the density is uniform through the coating layer. For example, the interior layer 121 can have a first density, and the exterior layer 122 can have a second density that is greater than the first density.

In some implementations, one or more coating layers around the fuel kernel 110 may have a graded density within the coating layer. For example, within the interior layer 121, the density may increase along an outward radial direction. Similarly, within the exterior layer 122, the density may increase along the outward radial direction. The outward radial direction can be defined as a direction from the center 125 of the fuel kernel 110 towards the outer surface of the fuel coating 120.

In some implementations, the fuel coating 120 can include at least one coating layer having a uniform density, and at least one coating layer having a graded density. For example, the interior layer 121 may have a uniform density, and the exterior layer 122 may have a density that increases along the outward radial direction.

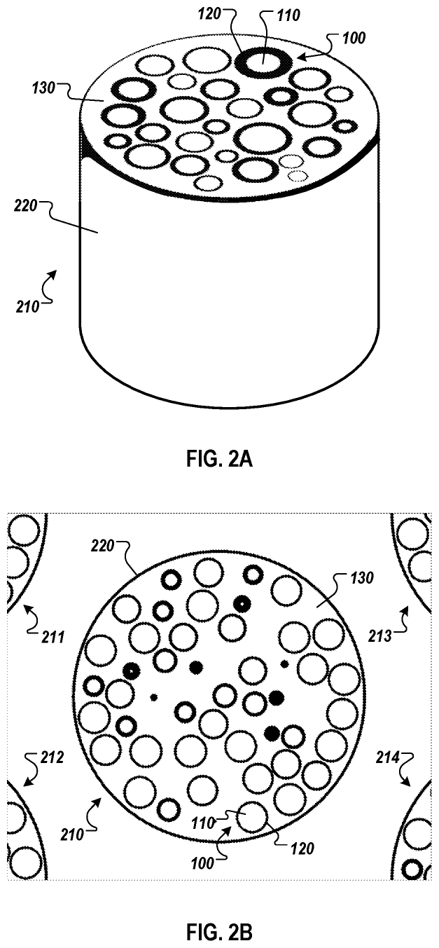

FIGS. 2A and 2B are schematic illustrations showing top cross-sectional views of an example implementation of a coated particle fuel compact 210 according to the present disclosure. The example fuel compact 210 has a solid cylindrical shape. FIG. 2A shows a perspective view of the fuel compact 210, including a cross-sectional top view of the coated fuel particles 100 in the fuel compact 210. FIG. 2B shows a cross-sectional top view of the fuel compact 210. The fuel compact 210 is shown in proximity to other fuel compacts 211, 212, 213, 214.

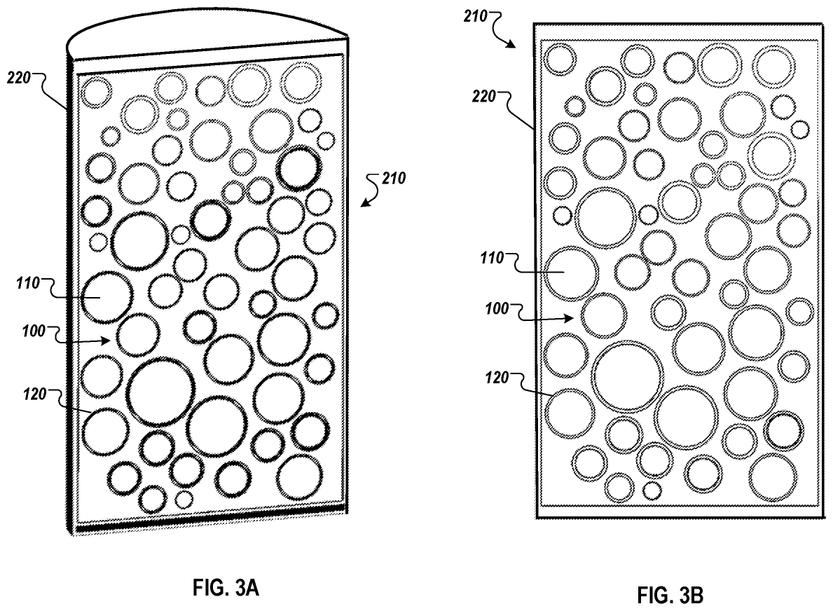

FIGS. 3A and 3B are schematic illustrations showing side cross-sectional views of an example implementation of the coated particle fuel compact 210 according to the present disclosure. FIG. 3A shows a perspective view of the fuel compact 210, including a cross-sectional side view of the coated fuel particles 100 in the fuel compact 210. FIG. 3B shows a cross-sectional side view of the fuel compact 210.

Although the fuel compact 210 shown in FIGS. 2A, 2B, 3A, and 3B has a cylindrical shape, in some examples, a fuel compact can have a spherical shape. In some examples, a fuel compact can have an annular cylindrical shape. In some examples, a fuel compact can have a rectangular prism or cuboid shape.

The fuel compact 210 includes coated fuel particles 100 in the matrix material 130. The coated fuel particles 100 can be packed together in volume fractions, or packing fractions, ranging from under thirty-five percent to over sixty percent of the fuel compact volume. In some implementations, a volume fraction of coated fuel particles 100 in the matrix material 130 is forty percent or greater (e.g., forty-five percent or greater, fifty percent or greater, fifty-five percent or greater).

The matrix material 130 can be fabricated by, e.g., spark plasma sintering methods and can act as a barrier to fission product release. The matrix material 130 can include graphite, silicon carbide, zirconium carbide, zirconium diboride, or a combination of these materials. The matrix material 130 can have a density of approximately seventy-five percent to one hundred percent. In some implementations, the matrix material 130 has a density of ninety percent or greater (e.g., ninety-two percent or greater, ninety-five percent or greater, ninety-seven percent or greater). In some implementations, the matrix material 130 has a density of ninety percent or greater, and the fuel compact 210 does not have a fuel element coating 220. In some implementations, the matrix material 130 has a density of less ninety percent, and the fuel element coating 220 is applied to the fuel compact 210. The fuel element coating 220 can be fully, dense, e.g., having a density of between ninety percent and one hundred percent.

The fuel coating 120, matrix material 130, or both, can include composite materials. The fuel coating 120, matrix material 130, or both can include composite materials in order to achieve desired performance characteristics, such as resilience against degradation due to hydrogen exposure or oxygen exposure. In some examples, the fuel coating 120 or matrix material 130 can act as fixed absorbers or burnable poisons. In some examples, the fuel coating 120, matrix material 130, or both can act as moderators or can contain neutron moderating materials, such as metal hydrides.

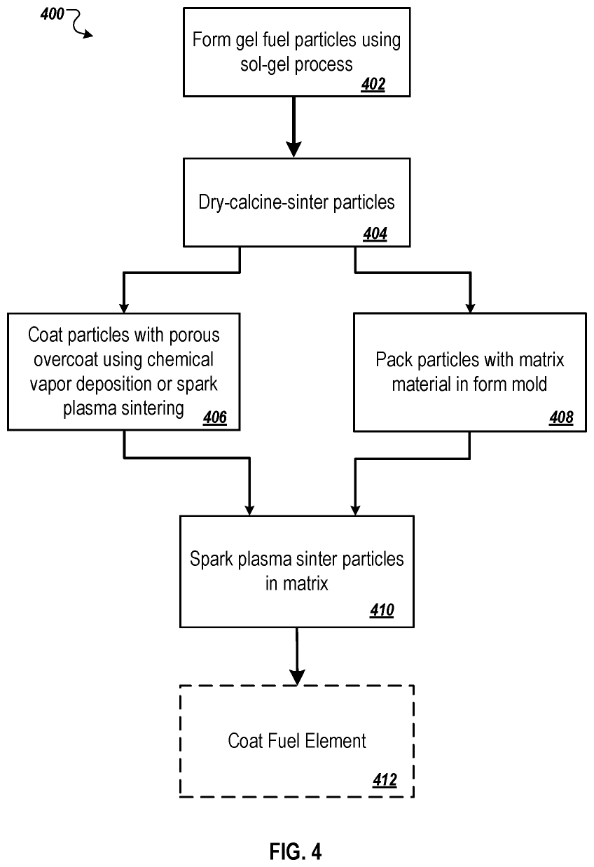

FIG. 4 is a flow diagram of an example process 400 for fabricating fuel elements according to the present disclosure. The process 400 includes forming gel fuel particles using a sol-gel process (402). A sol-gel process is a method for producing solid materials from small molecules. The method is used for the fabrication of metal oxides. The process involves conversion of monomers into a colloidal solution (sol) that acts as the precursor for an integrated network (or gel) of either discrete particles or network polymers.

The process 400 includes at least one of drying, calcining, or sintering the particles (404). Drying is thermal removal of liquid moisture (not chemically bound) from a material. Drying is usually accomplished by contacting the moist solids with hot combustion gases. Calcination refers to heating a solid to high temperatures in absence of air or oxygen. Sintering is the process of compacting and forming a solid mass of material by heat or pressure at a temperature below the melting point to cause agglomeration of mineral particles into a porous and lumpy mass by incipient fusion caused by heat produced by combustion of solid fuel within the mass itself. The atoms in the material diffuse across the boundaries of the particles, fusing the particles together and creating one solid piece. Sintering can be performed as a heat treatment to increase the strength and structural integrity of the material. The drying, calcining, and sintering processes are performed to obtain kernels of a desired size and density.

The process 400 includes coating particles with a porous overcoat (406) or packing particles with matrix material in a form mold (408). For example, in some aspects, particles can be coated separately or particles can be put into a matrix material uncoated. Sintering dynamics with the matrix/particle interface can induce a desired functional grading, or the desired functional grading can be suppressed through sintering control such that a coating has full density around the particle. This can be done where the functional grading, e.g., a porous buffer layer, is not needed, such as for a short duration nuclear thermal propulsion system that uses the fuel particles.

The particles can be coated with the porous overcoat using vapor deposition or spark plasma sintering. Spark plasma sintering is a sintering method that can also be known as field assisted sintering, pulsed electric current sintering, or plasma pressure compaction. During spark plasma sintering, heat results in the densification of powder compacts, which results in achieving improved density at lower sintering temperature compared to conventional sintering techniques. The heat veneration is internal, which facilitates a very high heating or cooling rate (up to 1000 K/min). Thus, the sintering process generally is very fast (e.g., within a few minutes).

Vapor deposition, e.g., chemical vapor deposition, is a vacuum deposition method used to produce high quality, and high-performance, solid materials. The process can be used to produce and apply thin films. In vapor deposition, a substrate is exposed to one or more volatile precursors, which react and/or decompose on the substrate surface to produce the desired deposit. Vapor deposition can be used to deposit conformal films and augment substrate surfaces. Vapor deposition can be used to produce coatings with sufficient thickness and uniformity. The particles are coated with the porous overcoat to produce coated fuel particles 100.

The process 400 includes spark plasma sintering particles in the matrix (410). The matrix can be made from the matrix material 130. The particles sintered in the matrix form a fuel element, e.g., fuel compact 210.

The process 400 optionally includes coating the fuel element (412). For example, for a fuel element with a matrix material 130 having a density of less ninety percent, the fuel element can be coated with a fully dense fuel element coating 220. The fuel element coating 220 may be formed from a material have a density of one hundred percent or nearly one hundred percent, e.g., a density between ninety-five and one hundred percent. As examples, the coating of the fuel element can be one or more of graphite, silicon carbide, niobium carbide, hafnium carbide, tantalum carbide, titanium carbide, or zirconium carbide. The coating of the fuel element can also be a nitride, such as hafnium nitride, boron nitride, titanium nitride, or zirconium nitride. The coating of the fuel element can also be a boride, such as hafnium boride, niobium boride, titanium boride, or zirconium boride.

In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A nuclear fuel system, comprising:
a matrix material; and
a plurality of fuel particles disposed in the matrix material, each fuel particle comprising:
a fuel kernel; and
at least one fuel coating that covers a surface of the fuel kernel.

2. The nuclear fuel system of claim 1, wherein the fuel kernel comprises a fissile material.

3. The nuclear fuel system of claim 2, wherein the fissile material comprises one or more of uranium-233, uranium-235, or plutonium-239, uranium oxide, uranium oxycarbide, uranium nitride, uranium silicide, or uranium boride.

4. The nuclear fuel system of claim 1, wherein the at least one fuel coating is functionally graded in density.

5. The nuclear fuel system of claim 1, wherein a density of the at least one fuel coating increases along an outward radial direction referenced to a center of the fuel kernel.

6. The nuclear fuel system of claim 1, wherein the surface comprises an entire surface of the fuel kernel.

7. The nuclear fuel system of claim 1, wherein the at least one fuel coating is fabricated using chemical vapor deposition methods or spark plasma sintering methods.

8. The nuclear fuel system of claim 1, wherein the at least one fuel coating comprises a neutron moderating material.

9. The nuclear fuel system of claim 8, wherein the neutron moderating material comprises one or more of graphite or beryllium.

10. The nuclear fuel system of claim 1, wherein the at least one fuel coating comprises a cercer material.

11. The nuclear fuel system of claim 10, wherein the cercer material comprises one or more of a boride, a nitride, or a silicide.

12. The nuclear fuel system of claim 1, wherein the at least one fuel coating comprises an interior layer and an exterior layer.

13. The nuclear fuel system of claim 12, wherein the exterior layer comprises a same material composition as the matrix material.

14. The nuclear fuel system of claim 12, wherein the interior layer comprises a material having a reduced density compared to a density of a material of the exterior layer.

15. The nuclear fuel system of claim 14, wherein the material of the interior layer comprises at least one of graphite, silicon carbide, niobium carbide, hafnium carbide, tantalum carbide, titanium carbide or zirconium carbide.

16. The nuclear fuel system of claim 14, wherein the material of the interior layer comprises at least one of hafnium nitride, boron nitride, titanium nitride or zirconium nitride.

17. The nuclear fuel system of claim 14, wherein the material of the interior layer comprises at least one of hafnium boride, niobium boride, titanium boride or zirconium boride.

18. The nuclear fuel system of claim 1, wherein the matrix material is fabricated using spark plasma sintering methods.

19. The nuclear fuel system of claim 1, wherein the matrix material comprises one or more of silicon carbide, niobium carbide, hafnium carbide, tantalum carbide, titanium carbide or zirconium carbide.

20. The nuclear fuel system of claim 1, wherein the matrix material comprises a neutron moderating material.

21. The nuclear fuel system of claim 1, wherein the at least one fuel coating and the matrix material are materially compatible.

22. The nuclear fuel system of claim 1, further comprising a nuclear fuel compact manufactured via spark plasma sintering, wherein the plurality of fuel particles and the matrix material are disposed in the nuclear fuel compact.

23. The nuclear fuel system of claim 22, wherein a volume fraction of fuel particles is thirty-five percent or more of a volume of the nuclear fuel compact.

24. The nuclear fuel system of claim 22, wherein a volume fraction of fuel particles is fifty-percent or more of a volume of the nuclear fuel compact.

25. The nuclear fuel system of claim 1, wherein the fuel kernel comprises at least one of an oxide, a carbide, an oxycarbide, a boride, or a nitride.

26. The nuclear fuel system of claim 1, wherein the at least one fuel coating that covers the surface of the fuel kernel comprises a single coating layer comprising a porous material.

27. A nuclear fuel particle, comprising:
a fuel kernel; and
at least one fuel coating that covers a surface of the fuel kernel.

28. The nuclear fuel particle of claim 27, wherein the fuel kernel comprises a fissile material.

29. The nuclear fuel particle of claim 28, wherein the fissile material comprises one or more of uranium-233, uranium-235, or plutonium-239.

30. The nuclear fuel particle of claim 27, wherein the at least one fuel coating is functionally graded in density.

31. The nuclear fuel particle of claim 27, wherein a density of the at least one fuel coating increases along an outward radial direction referenced to the center of the fuel kernel.

32. The nuclear fuel particle of claim 27, wherein the surface comprises an entire surface of the fuel kernel.

33. The nuclear fuel particle of claim 27, wherein the at least one fuel coating is fabricated using chemical vapor deposition methods or spark plasma sintering methods.

34. The nuclear fuel particle of claim 27, wherein the at least one fuel coating comprises a neutron moderating material.

35. The nuclear fuel particle of claim 34, wherein the neutron moderating material comprises one or more of graphite or beryllium.

36. The nuclear fuel particle of claim 27, wherein the at least one fuel coating comprises a cercer material.

37. The nuclear fuel particle of claim 36, wherein the cercer material comprises one or more of a boride, a nitride, or a silicide.

38. The nuclear fuel particle of claim 27, wherein the at least one fuel coating includes an interior layer and an exterior layer.

39. The nuclear fuel particle of claim 38, wherein the exterior layer comprises a same material composition as a matrix material that surrounds the nuclear fuel particle.

40. The nuclear fuel particle of claim 39, wherein the interior layer comprises a reduced density material having a reduced density compared to the exterior layer.

41. The nuclear fuel particle of claim 40, wherein the reduced density material comprises at least one of graphite, silicon carbide, or zirconium carbide.

42. The nuclear fuel particle of claim 27, wherein the at least one fuel coating is materially compatible with matrix material that surrounds the nuclear fuel particle.

43. The nuclear fuel particle of claim 27, wherein the fuel kernel comprises at least one of an oxide, a carbide, an oxycarbide, a boride, or a nitride.

44. The nuclear fuel particle of claim 27, wherein the at least one fuel coating that covers the surface of the fuel kernel comprise a single coating layer comprising a porous material.

45. A method, comprising:
facilitating a fission process with a plurality of nuclear fuel elements;
generating heat from the fission process; and
producing electrical power using the heat generated from the fission process, wherein each nuclear fuel element of the plurality of nuclear fuel elements comprises:
a matrix material; and
a plurality of fuel particles disposed in the matrix material, each fuel particle comprising a fuel kernel, and at least one fuel coating that covers a surface of the fuel kernel.

46. A method of fabricating a nuclear fuel element, comprising:
forming a plurality of fuel particles using a sol-gel process;
drying the fuel particles;
calcining the fuel particles;
sintering the fuel particles;
coating the fuel particles with a fuel coating;
packing the coated fuel particles in a matrix material; and
sintering the coated fuel particles in the matrix material to form the nuclear fuel element.

47. The method of claim 46, further comprising coating the nuclear fuel element in a fuel element coating.
